(19) United States
(12) Patent Application Publication
(10) Pub. No.: US 2021/0315403 A1
(43) Pub. Date: Oct. 14, 2021

(54) PRINCE MCCOWAN VIDEO SMART MAIL PACKAGE

(71) Applicant: RICHARD ALLEN PRINCE, II, DESOTO, TX (US)

(72) Inventor: RICHARD ALLEN PRINCE, II, DESOTO, TX (US)

(21) Appl. No.: 15/420,183

(22) Filed: Jan. 31, 2017

(51) Int. Cl. A47G 29/122; A47G 29/124; A47G 29/126; G08B 3/10

(52) U.S. Cl. CPC A47G 29/1225; A47G 29/1248; A47G 29/126; A47G 2200/14; A47G 2029/1226; A47G 2200/085; A47G 2200/166; G08B 3/1016

(57) ABSTRACT

Millions of packages get shipped and stolen from home door steps, mail often get placed in wrong mailboxes and sometimes the mailman or package carrier needs to speak to someone at or from the residence, Video Smart Package Pillar” was created with all of these issues of the world in mind, combining the idea of a Pillar, compartmentalized, with two compartments—a mail compartment and package compartment and a one to two doors in rear to obtain packages that have been delivered. While leaving an original mail pull down opening for the mail being delivered.

Millions of packages get shipped and stolen from home door steps, mail often get placed in wrong mailboxes and sometimes the mailman or package carrier needs to speak to someone at or from the residence, Video Smart Package Pillar” was created with all of these issues of the world in mind, combining the idea of a Pillar, compartmentalized, with two compartments—a mail compartment 22 and package compartment 23. One to two doors 1 in rear to obtain packages that have been delivered. While leaving an original mail pull down 22 opening for the mail being delivered, keeping both mail carriers and package handlers in a separate location for their deliveries all combined on one unit 24, along with technologies such as an automated “door like” top cover hatch 10 that opens and closes with a button 3 and sensors 15 to auto close when packages are placed into the package storage area 23 powered by solar panel 18 and a internal battery that sources to keep and maintain power. There is a camera 2 with microphone and speaker, along with separate sensors 2 that allow it to be turned on when motion is happening, night vision to be able to see people or animals when it's low light or night. Inside the package area there are also lights 12 to see packages in low light or night times as well as charms, alarms, and alerts 2 to let you know if your unit is being tampered with. 7 internal actuator—the device used to connect the top lid and base. 8 internal hub shaft-the area where packages will slide to the base. 9 internal top shaft-the area where the postal service can place regular mail. 11 internal weight handler-the system used to make sure packages lower themselves to the bottom of the hub without breaking, gives them a softer landing. Handles weight variations. 13 internal temperature regulator-the system that regulates temperature; keeping the internal shafts at a suitable temperature for packages and mail. 14 internal door sensor-the systems device developed to give notifications on devices of various actions that may be happening within the mail box or to the door. 15 internal sensor door lock latch for top raise door. This sensor lock latch is to show various actions and make various actions like locking, opening, sending notifications of its state. 16 exterior sensor door lock for door hub. This lock is a lock and sensor for opening hub, it sensors have various capabilities like sending temperature readings, smart open and lock and chime alarm. 19 internal liquid drain holes—Holes inserted for drainage if moisture gets inside the hub, the holes will be placed in the hub. 20 exterior light-A lighting system that's solar for the outside of the mailbox. 21 internal light for top shaft-Is a lighting system for the top shaft that turns on with the system when opening. 26 bottom base is a formulated base platform to hold hub in place against weather and weight. 27 front of mailbox is the front facing viewpoint of mailbox of where the camera lighting and entrance of mail and package functions are. 28 mail compartment door—is the door that opens and shut for postal carriers to load mail. 29 access to belt down—is the compartment accessible to the belt that raises and shut the top lid. 31 front door hinges—are the hinges that latch to the front mail door. 32 exterior stone—is one form decoration that comes apart of the outer layer of the hub 34 internal wiring—the wiring system that connects to power source to make function. 5 internal left pull wire is the wire attached to the lid, it helps the door raise on the left side. 6 internal right pull wire is the wire attached to the lid, it helps the door raise on the right side.

The design is to be set at normal and regulated mailbox areas as well as close to door on property.

The apartment design has a metal latch grip that mounts to the top of apartment or condo door. It's sizes custom but has four sides a top and a bottom. Where the top is an automated “door like” hatch that opens with a button. The apartment version comes only for small or normal sized packages, it's body drops just below the peep hole, to keep from blocking the residences view. The model comes with same video camera that has microphone and speaker so the resident can be anywhere and still be able to see someone delivering packages or trying to steal them. These units are theft deterrent.

Our invention is unique by design and use for our invention creates a way a regulated mailbox combined with a custom package storage for storing packages separate from mail, but still connected with the same unit with security camera and special sensors and alerts to create a unique theft deterrent system for the packages and mail that's being delivered.

### BRIEF DESCRIPTION OF DRAWINGS

FIG. 1 This image is of side top portion of mail pillar dealing with opening access with solar panel arrow pointing at the location of the panel and handle that will be attached to the exterior door

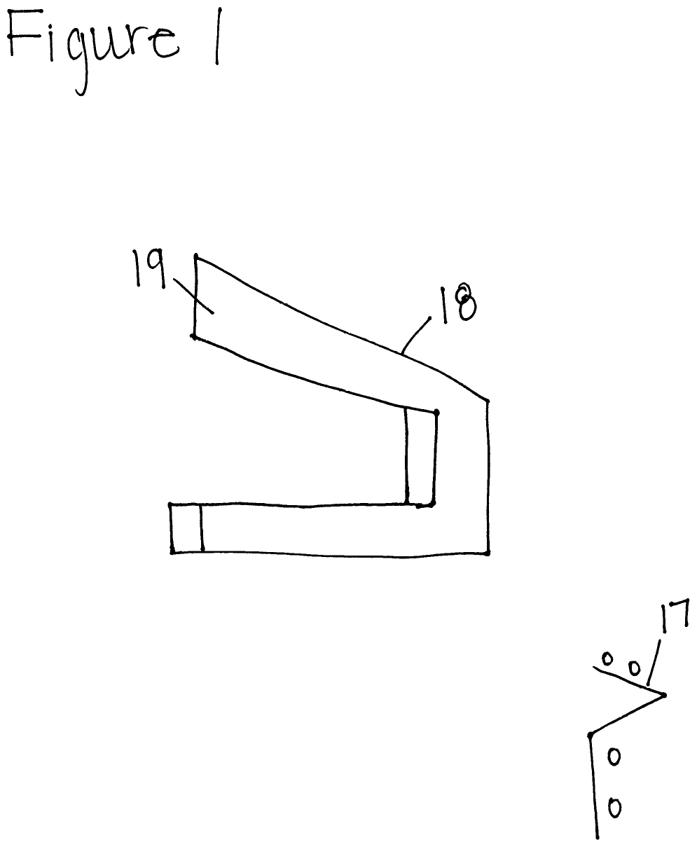

FIG. 2 This image is of the bottom base of the pillar showing the shape and that its piece will connect to bottom of mail pillar and will have drain holes for in corners to keep packages or whatever is placed inside dry or as dry as can be.

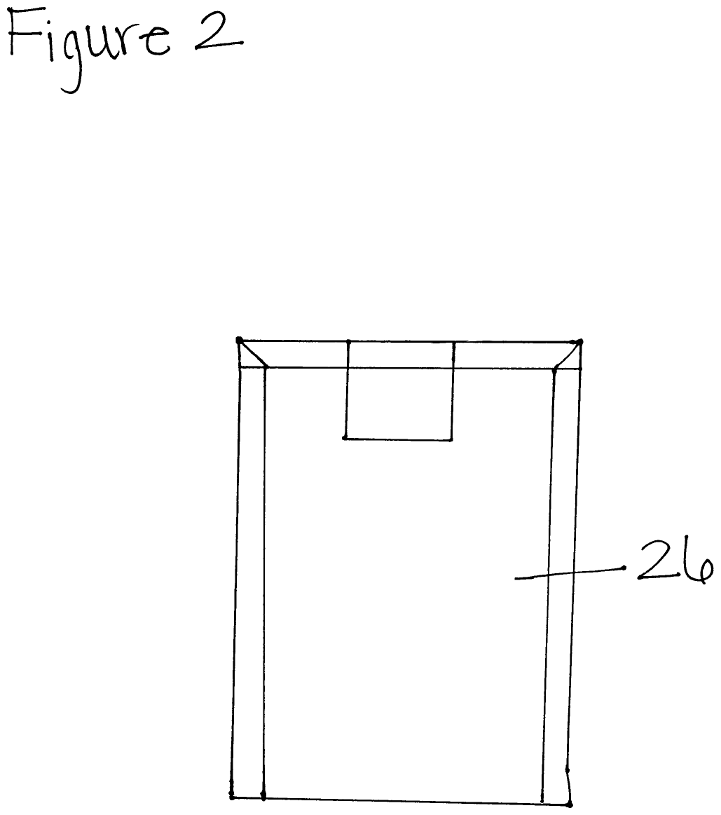

FIG. 3 This image is of the side view of package pillar detailing actions of lid opening and its chambers inside

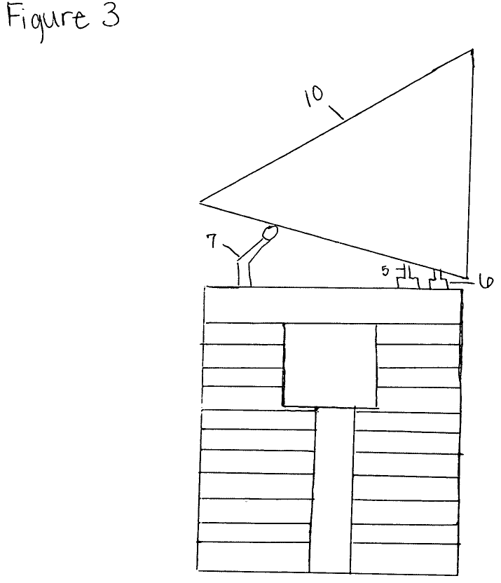

FIG. 4 This image is a photo of front view package pillar of inside chambers to detail inside actions and accessories

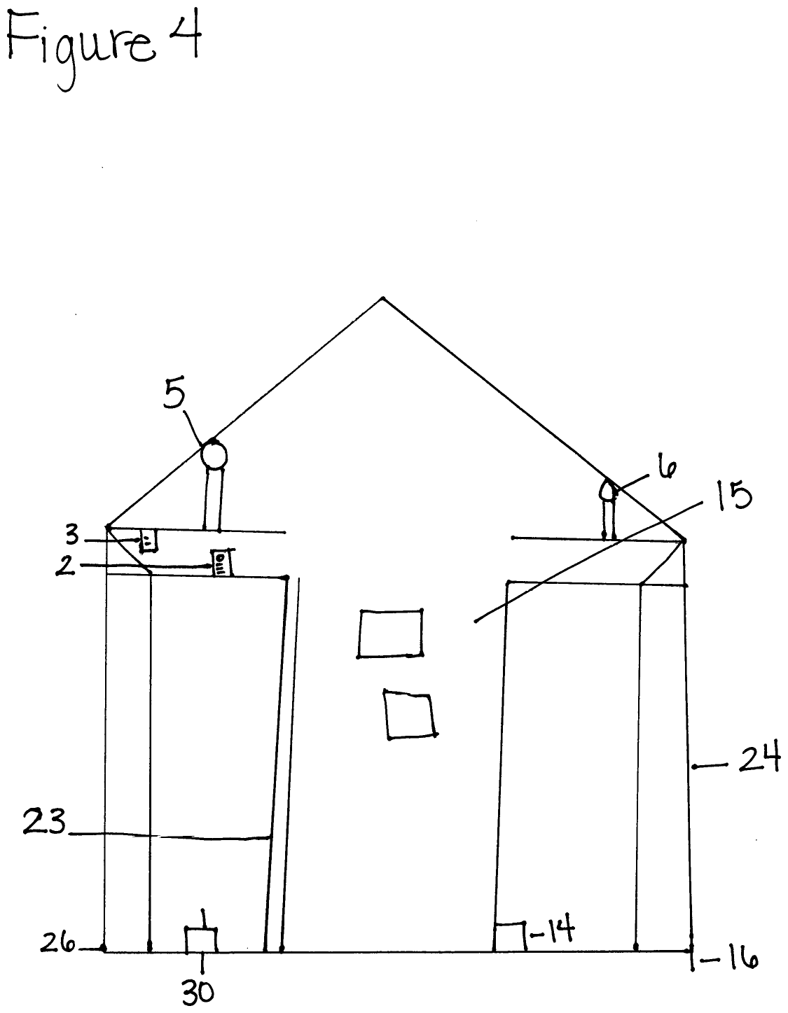

FIG. 5 This image is a photo of top view package pillar base and solar panel the top view shows the angle front top view as if someone was looking down at he pillar

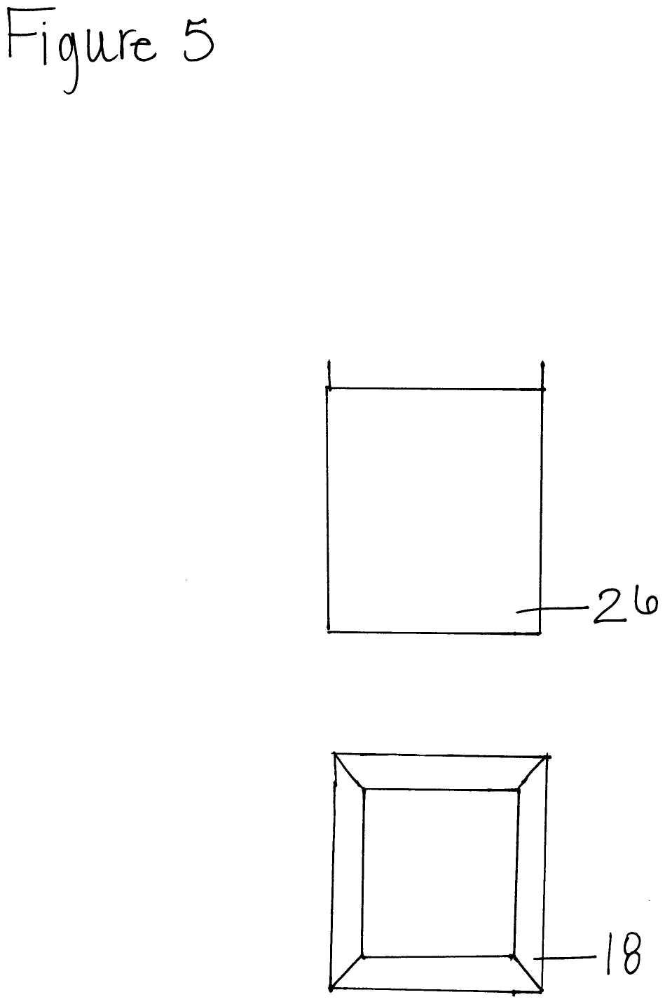

FIG. 6 The image is of the back view before door enlargements to show various ways the pillar could be crafted where the bottom shows a smaller door at bottom

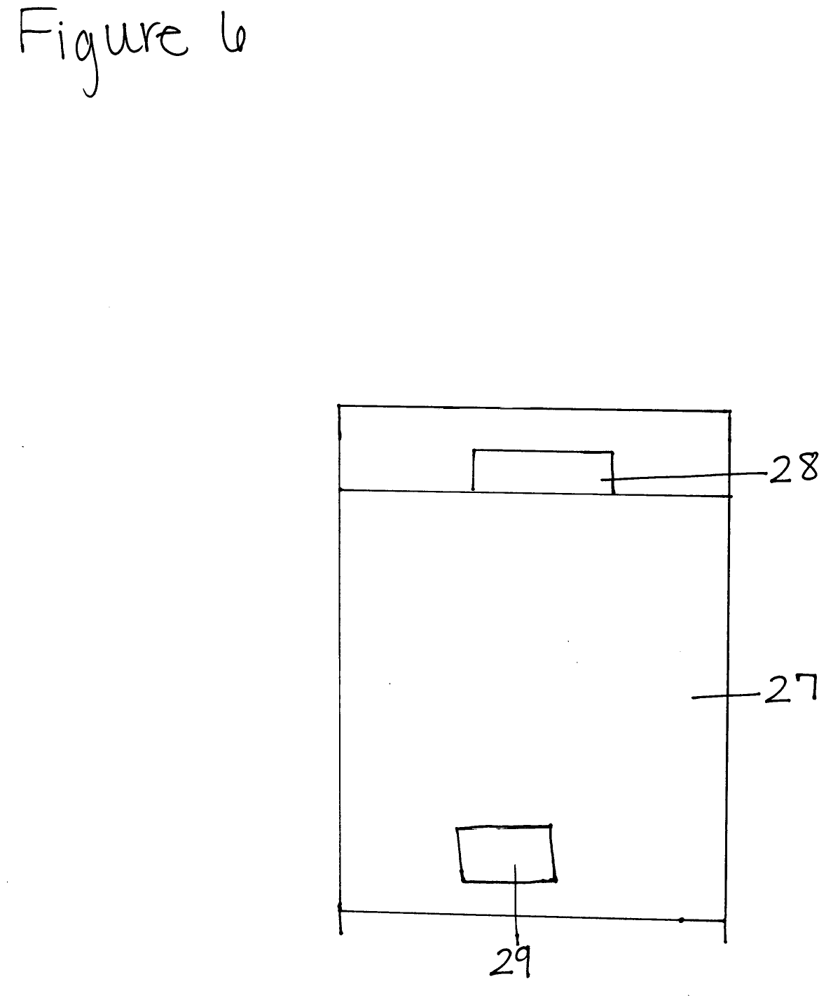

FIG. 7 The image shows left sided view of pillar detailing the chambers

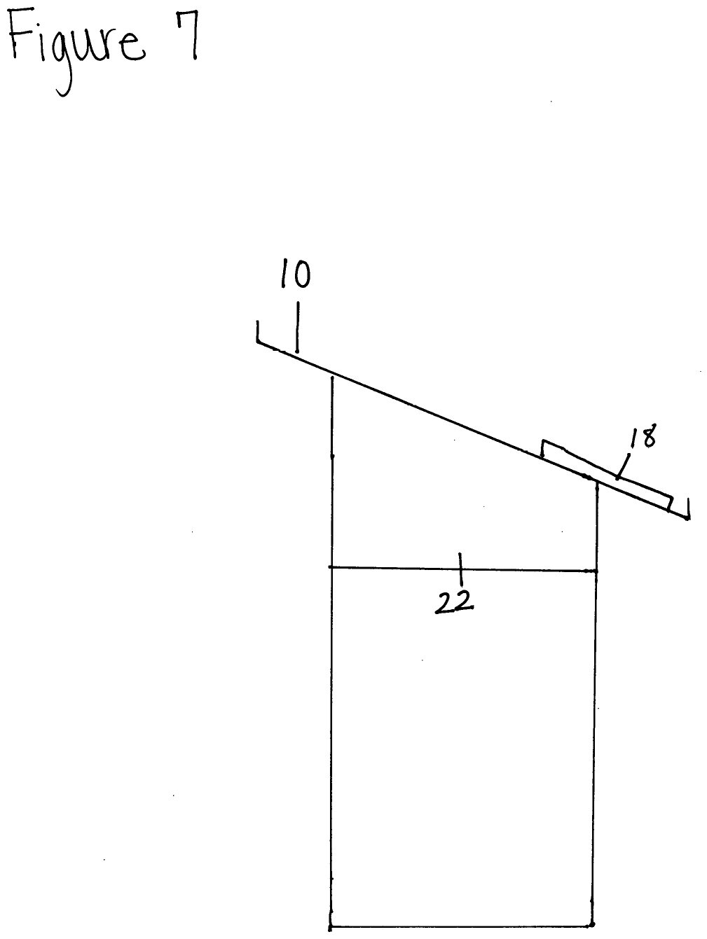

FIG. 8 The image shows a left side point of view detailing how the chambers work and connected parts that make it work

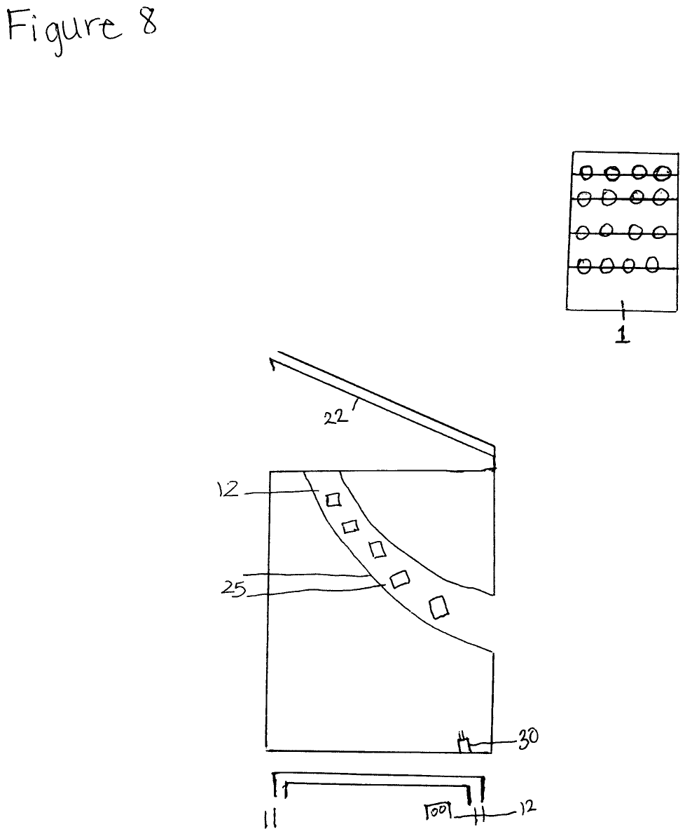

FIG. 9 This image is a left sided view of pillar detailing featured pieces as well as parts used to put pillar together

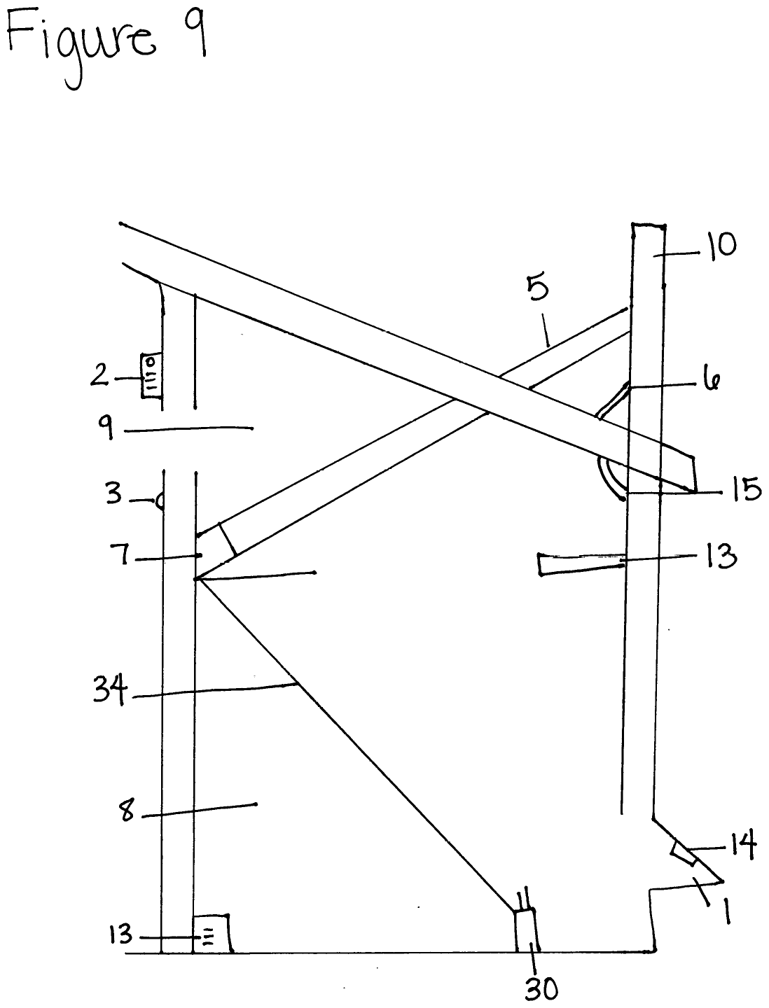

FIG. 10 This image is of key parts of the pillar that are used for the mail pull down door

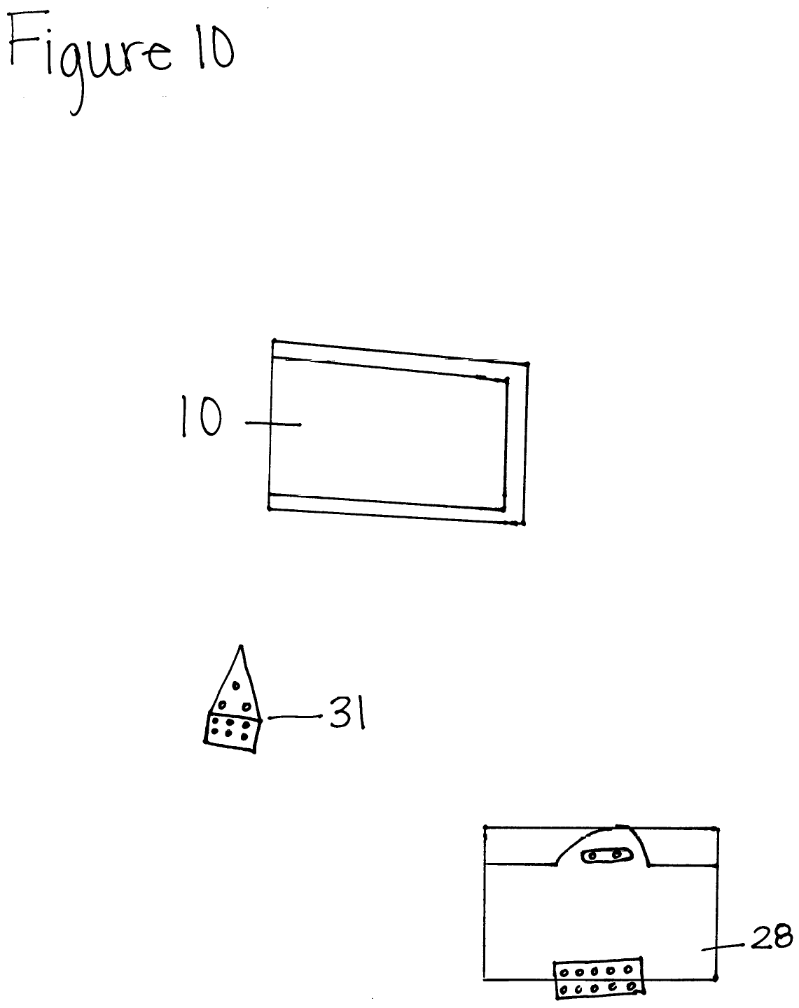

FIG. 11 This image is an example of what exterior decor could be used to dress up the pillar stone etc.

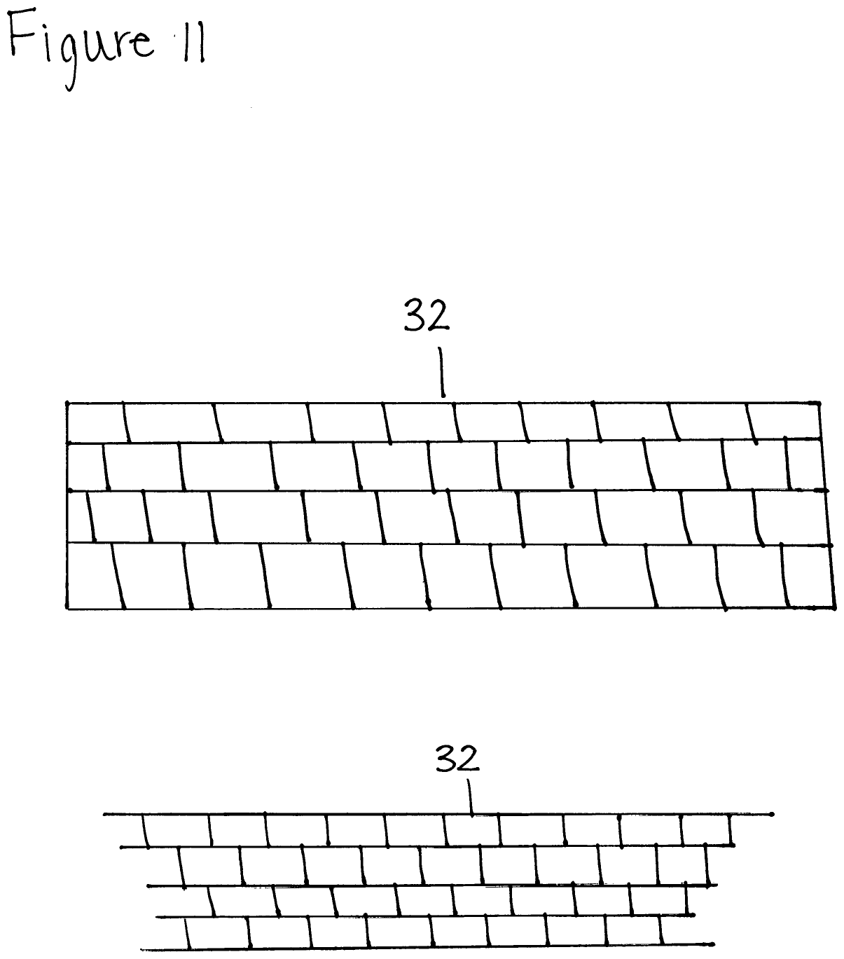

FIG. 12 This image is of a full front of the pillar with a partial see through of back door along with added features concept and shape

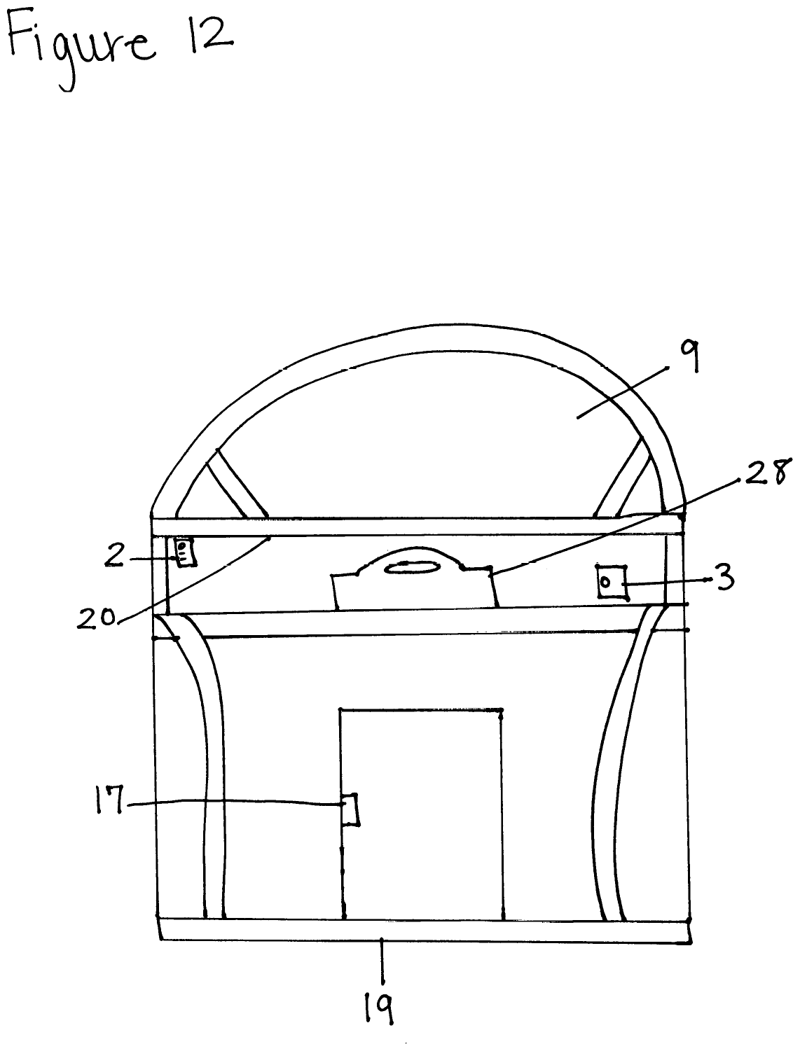

### LISTING OF REFERENCE NUMERALS

1 back pull door

2 video sensor camera

3 lever button

4 internal pull pad

5 internal left pull wire

6 internal right pull wire

7 internal actuator

8 internal hub shaft

9 internal top shaft

10 top raise door

11 internal weight handler

12 internal sensor light

13 internal temperature regulator

14 internal door sensor

15 internal sensor door lock latch for top raise door

16 exterior sensor door lock for door hub

17 exterior door handle

18 solar panel

19 internal liquid drain holes

20 exterior light

21 internal light for top shaft

22 mail compartment

23 package compartment

24 whole pillar/unit

25 interior package slope

26 bottom base

27 front of mailbox

28 mail compartment door

29 access to belt down

30 internal battery

31 front door hinges

32 exterior stone

34 internal wiring

We claim:

1. An apparatus theft deterrent mailbox pillar comprising of a video and audio recording, a photo taking camera connected to the mailbox pillar; an electronic button connected to its top moving door. consisting on actuators, connected to pull wires, an internal moving dividing flap for bottom package compartment, a double compartment delivery and retrieval system consisting of lights, alert sensors, temperature gages, and alarms connected to its doors and sides comprising of technology for mobile connection and weather alerts its back door is comprised of electronic locking and package retrievals.

2. The mailbox according to claim 1, further comprising: a second larger mail compartment.

3. The connecting Mail compartment and said Package compartment pillar joint with camera and said two-way audio.

4. The mailbox according to claim 1, further comprising:
a top flap door connected to said actuators and said pull wires to raise and close to receive packages.

5. The mailbox according to claim 1 further comprising: A smart sensors connected to doors said compartments inside said package pillar.

6. The mailbox according to claim 1 further comprising: A smart sensor lights inside package pillar.

7. The mailbox according to claim 1 further comprising: the function of how the video smart package pillar doors open from top, front, and rear to accept and receive.

8. Wherein according to claim 1: the function of alerts and alarms that send noise or recording and mobile alerts when tampered with.

9. The mailbox according to claim 1 further comprising: a smart lock and latch connected to said shaft door.

10. The mailbox according to claim 1 further comprising: a solar panel top door to recharge.

11. The mailbox according to claim 1 further comprising: the design of the power system of Package pillar in relating to combination of said solar and battery to power sensors door latches buttons.

12. The mailbox according to claim 1 further comprising: said sensor lights connected to inside shaft for inside package pillar and mail compartment for visibility in low or no light times.

13. The mailbox according to claim 1 further comprising: layered cooling and heating parts along with drain holes to keep mail and packages from overheating or sustaining moisture to keep mail and packages safe dry.

14. The mailbox according to claim 1 further comprising: of said concept and design of Mail package Pillar for said homes or buildings.

15. The mailbox according to claim 1 further comprising: wherein a concept and design of said mail package Pillar for apartments and small occupancy spaces.

16. Mailbox according to claim 1: Comprising the idea to create a theft deterrent product that postal and shipping handlers within regulations can both deliver to a shared space that would minimize theft and create more privacy yet more visible and accessible to both shipper and receiver.
